(19) United States
(12) Patent Application Publication
(10) Pub. No.: US 2025/0133455 A1
(43) Pub. Date: Apr. 24, 2025

(54) METHOD AND SYSTEM FOR MANAGING INTER RADIO ACCESS TECHNOLOGY (RAT) HANDOVER OF USER EQUIPMENT (UE)

(71) Applicant: SAMSUNG ELECTRONICS CO., LTD., Suwon-si (KR)

(72) Inventors: Dibyajyoti PATI, Bangalore (IN); Jajohn MATHEW MATTAM, Bangalore (IN)

(73) Assignee: SAMSUNG ELECTRONICS CO., LTD., Suwon-si (KR)

(21) Appl. No.: 18/825,558

(22) Filed: Sep. 5, 2024

(30) Foreign Application Priority Data
Oct. 20, 2023 (IN) 202341071739

(51) Int. Cl. H04W 36/00

(52) U.S. Cl. CPC H04W 36/00838; H04W 36/0085

(57) ABSTRACT

A method of managing inter Radio Access Technology (RAT) handover of a User Equipment (UE) in a wireless communication system, includes: detecting, by the UE, a communication session established via a higher priority RAT managed by a network; determining, by the UE, whether measurements related to a lower priority RAT is configured in the UE by the network; detecting, by the UE, a temperature of the UE, the temperature being reaching each of a plurality of pre-defined temperature levels, wherein the plurality of pre-defined temperature levels are lesser than a pre-defined maximum temperature level; and transmitting, by the UE, one or more requests to the network for performing inter RAT handover from the higher priority RAT to the lower priority RAT, based on the determined measurements and the detected communication session.

### CROSS-REFERENCE TO RELATED APPLICATIONS

This application is based on and claims priority under 35 U.S.C. § 119 to Indian Patent Application No. 202341071739, filed on Oct. 20, 2023, in the Indian Intellectual Property Office, the disclosure of which is incorporated by reference herein in its entirety.

### BACKGROUND

### 1. Field

The disclosure relates to telecommunication networks. More particularly, the disclosure relates to a method and a system for managing inter Radio Access Technology (RAT) handover of User Equipment (UE) in a wireless communication system.

### 2. Description of Related Art

Wireless communication systems are rapidly evolving. There is a significant development of the wireless communication systems from First Generation (1G) networks to Fifth Generation (5G) networks, and so on. This rapid development of the wireless communication systems has led to improved capabilities of networks such as high bandwidth, high power transmission, high data speeds, and the like. However, a requirement of such improved capabilities leads to increase in temperature of User Equipments (UEs). For instance, high-power processors are required in the UE to support the improved capabilities which consumes more power. This leads to increase in temperature of the UE. In some cases, the UE may be using higher bandwidth for a longer duration of time, which leads to increase in temperature of the UE. The increase in temperature of the UE can cause damage to components of the UE, injuries to a user operating the UE, discomfort to the user, and the like.

Conventionally, thermal mitigation techniques are used to manage temperature increase of the UE. The thermal mitigation techniques ensure that power dissipation from the UE is kept at acceptable levels, which leads to increase in the temperature. In the conventional thermal mitigation techniques, when temperature increases, the UE takes actions such as uplink data throttling, downlink data throttling, receiver diversity disabling, New Radio (NR) drop in Non-Standalone (NSA) architecture, Long-Term Evolution (LTE) fallback from NR in Standalone (SA) architecture, and the like.

In conventional thermal mitigation technique of LTE fallback from NR in the SA architecture, a session of the UE is dropped from NR to LTE, when the temperature rises above an acceptable level. The session of the UE is interrupted, and the NR is dropped. Further, an LTE cell is searched, and the UE camps on the LTE cell. Then, the UE performs a registration procedure to continue the session. This process takes around 1 second to more than 15 seconds based on availability of LTE cells in a stored list of the UE. The UE cannot access any service during this process, which affects Quality of Service (QOS) to the user.

The information disclosed in this background of the disclosure is only for enhancement of understanding of the general background of the invention and should not be taken as an acknowledgement or any form of suggestion that this information forms the prior art already known to a person skilled in the art.

### SUMMARY

Provided is a method of managing inter Radio Access Technology (RAT) handover of a User Equipment (UE) in a wireless communication system.

According to an aspect of the disclosure, a method of managing inter Radio Access Technology (RAT) handover of a User Equipment (UE) in a wireless communication system, includes: detecting, by the UE, a communication session established via a higher priority RAT managed by a network; determining, by the UE, whether measurements related to a lower priority RAT is configured in the UE by the network; detecting, by the UE, a temperature of the UE, the temperature being reaching each of a plurality of pre-defined temperature levels, wherein the plurality of pre-defined temperature levels are lesser than a pre-defined maximum temperature level; and transmitting, by the UE, one or more requests to the network for performing inter RAT handover from the higher priority RAT to the lower priority RAT, based on the determined measurements and the detected communication session.

According to an aspect of the disclosure, a User Equipment (UE) for managing inter Radio Access Technology (RAT) handover in a wireless communication system, includes: at least one processor; and at least one memory, wherein the at least one memory is configured to store processor-executable instructions, which, on execution, causes the at least one processor to: detect a communication session established via a higher priority RAT managed by a network; determine whether measurements related to a lower priority RAT is configured in the UE by the network; detect a temperature of the UE, the temperature being reaching each of a plurality of pre-defined temperature levels, wherein the plurality of pre-defined temperature levels are lesser than a pre-defined maximum temperature level; and transmit one or more requests, to the network, for performing inter RAT handover from the higher priority RAT to the lower priority RAT, based on the determined measurements and the detected temperature of the UE.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an example environment for managing inter Radio Access Technology (RAT) handover of a User Equipment (UE) in a wireless communication system, in accordance with some embodiments of the disclosure;

FIG. 2 illustrates a detailed diagram of the UE for managing the inter RAT handover in the wireless communication system, in accordance with some embodiments of the disclosure;

FIGS. 3A to 3C illustrate operations for managing the inter RAT handover of the UE in the wireless communication system, in accordance with some embodiments of the disclosure;

FIG. 4 illustrates operations for managing the inter RAT handover of the UE in the wireless communication system, in accordance with some embodiments of the disclosure; and

FIG. 5 illustrates a block diagram of a general-purpose computing system for managing the inter RAT handover of the UE in the wireless communication system, in accordance with embodiments of the disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the disclosure. In addition, descriptions of well-known functions and constructions may be omitted for clarity and conciseness.

The terms and words used in the following description and claims are not be limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

As used herein, the terms referring to merging (e.g., merging, grouping, combination, aggregation, joint, integration, unifying), the terms referring to signals (e.g., packet, message, signal, information, signaling), the terms referring to resources (e.g. section, symbol, slot, subframe, radio frame, subcarrier, resource element (RE), resource block (RB), bandwidth part (BWP), opportunity), the terms used to refer to any operation state (e.g., step, operation, procedure), the terms referring to data (e.g. packet, message, user stream, information, bit, symbol, codeword), the terms referring to a channel, the terms referring to a network entity (e.g., distributed unit (DU), radio unit (RU), central unit (CU), control plane (CU-CP), user plane (CU-UP), O-DU-open radio access network (O-RAN) DU), O-RU (O-RAN RU), O-CU (O-RAN CU), O-CU-UP (O-RAN CU-CP), O-CU-CP (O-RAN CU-CP)), the terms referring to the components of an apparatus or device, or the like are only illustrated for convenience of description in the disclosure. Therefore, the disclosure is not limited to those terms described below, and other terms having the same or equivalent technical meaning may be used therefor. Further, as used herein, the terms, such as ‘˜module’, ‘˜unit’, ‘˜part’, ‘˜body’, or the like may refer to at least one shape of structure or a unit for processing a certain function.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {'C′, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

In the disclosure, the word “example” is used herein to mean “serving as an example, instance, or illustration.” Any embodiment or implementation of the present subject matter described herein as “example” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Generally, requirements of improved capabilities such as high bandwidth, high data speeds in wireless communication systems have led to increase in temperature of User Equipments (UEs). Conventionally, thermal mitigation techniques are used to manage temperature increase of the UE. One such technique includes Long-Term Evolution (LTE) fallback from New Radio (NR) in which a session of the UE is dropped from NR to LTE, when the temperature rises above an acceptable level. An inter Radio Access Technology (RAT) handover from NR to LTE takes place, when the temperature rises above the acceptable level. The session of the UE is interrupted for a period of time until the UE camps on an LTE cell and completes a registration procedure. During said period of time, a user of the UE cannot access any services which affects Quality of Service (QOS) to the user.

Thus, the disclosure provides a method and a UE for managing inter RAT handover in a wireless communication system. In the disclosure, a plurality of temperature levels is defined. The plurality of temperature levels is lesser than a maximum temperature level at which an inter RAT handover needs to be performed from a higher RAT to a lower RAT (for instance, from NR to LTE). The UE detects whether temperature of the UE reaches each temperature level from the plurality of temperature levels. When the temperature of the UE reaches each temperature level, the UE transmits one or more requests to a network for performing the inter RAT handover from the higher RAT to the lower RAT. In the disclosure, the UE performs procedures such as configuring LTE measurements, determining an LTE cell for the inter RAT handover, and the like, in advance of the temperature of the UE reaching the maximum temperature level. Hence, the network can perform the inter RAT handover of the UE prior to the temperature of the UE reaching the maximum temperature level. This leads to a seamless handover from the higher RAT to the lower RAT to avoid service interruptions to a user associated with the UE, when a temperature level of the UE is high. This improves Qos provided to the user.

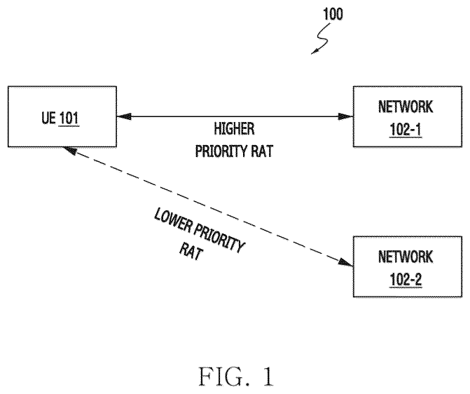

FIG. 1 illustrates an example environment 100 for managing inter Radio Access Technology (RAT) handover of a User Equipment (UE) in a wireless communication system, in accordance with the embodiments of the disclosure. The example environment 100 comprises a UE 101 and a plurality of networks 102-1 and 102-2. The UE 101 is configured to connect with network elements and other UEs in the wireless communication system. For example, the UE 101 may connect with a Fifth Generation (5G) base station to communicate with the other UEs. Examples of the UE 101 include, but not limited to, any device used by a user to communicate and/or access content such as, but not limited to, mobile phones, smartphones, laptops, wearables, Internet of Things (IoTs), and the like.

The UE 101 connects to a network via a RAT to communicate in the wireless communication system. RAT is an underlying physical connection method for a radio communication network. Examples of the RAT include, Global System for Mobile Communication (GSM), Long-Term Evolution (LTE) 5G New Radio (NR), and the like. Referring to FIG. 1, the UE 101 may be connected to a network 102-1 via a higher priority RAT. For example, the higher priority RAT may include 5G NR. The UE 101 may use services of the network 102-1 with improved capabilities when connected to the higher priority RAT. For instance, the UE 101 may use services with improved capabilities such as high data speeds, high bandwidth, and the like, when the UE 101 is using 5G NR technology. A temperature of the UE 101 may rise above an acceptable level, when using such improved capabilities. The acceptable level may be pre-defined for a specific implementation of the network 102. In such case, there may be an inter RAT handover required from the higher priority RAT to a lower priority RAT. In the disclosure, the UE 101 is configured to manage the inter RAT handover of the UE 101, for instance from the network 102-1 to the network 102-2. The network 102-1 to which the UE 101 is connected is referred as the network 102 hereafter in the present description.

Herein, the UE 101 may detect a communication session established via the higher priority RAT managed by a network 102. For instance, the UE 101 may detect that a user is on a call with another user using 5G service. Further, the UE 101 may determine whether measurements related to a lower priority RAT is configured in the UE 101 by the network 102. For instance, the lower priority RAT may be LTE. The UE 101 may determine whether measurements related to the lower priority RAT is configured for performing the handover from the higher priority RAT to the lower priority RAT, when the temperature of the UE 101 rises above the acceptable level. Further, the UE 101 may detect a temperature of the UE 101 reaching each of a plurality of pre-defined temperature levels. In the disclosure, the plurality of pre-defined temperature levels lesser than a pre-defined maximum temperature level is defined, such that the inter RAT handover is performed prior to the temperature of the UE 101 reaches the pre-defined maximum temperature level. The plurality of pre-defined temperature levels may be defined based on a specific implementation of the network 102 based on various network factors. In an example, the plurality of pre-defined temperature levels may be 36° C. and 40° C. In an example, the pre-defined maximum temperature level may be 42° C.

The UE 101 may transmit one or more requests to the network 102, based on the determination and detection. In a case where the network 102 has not configured the measurements related to the lower priority RAT in the UE 101, the UE 101 may perform following steps. Firstly, the UE 101 may transmit a first request to the network 102 for configuring the measurements related to the lower priority RAT in the UE 101, when the temperature of the UE 101 reaches a first pre-defined temperature level among the plurality of pre-defined temperature levels. The first request comprises information related to triggering of event A2 by the UE 101. The event A2 indicates a poor network condition of a serving cell associated with the UE 101. The event A2 may be triggered so that the network 102 configures the measurements of the lower priority RAT in the UE 101. Referring to above-stated example, the UE 101 may transmit the first request when the temperature of the UE 101 reaches 36° C.

Then, the UE 101 may transmit a second request to the network 102, for performing the inter RAT handover from the higher priority RAT to the lower priority RAT when the temperature of the UE 101 reaches a second pre-defined temperature level among the plurality of pre-defined temperature levels. The second request comprises information related to triggering one of, event B1 and event B2 by the UE 101. The second request indicates that a signal strength of neighboring cells of the UE 101, associated with the lower priority RAT, is better than that of the serving cell of the UE 101. The second request is transmitted identifying a cell (for instance, an LTE cell), to perform the inter-RAT handover from the higher priority RAT to the lower priority RAT. Referring to above-stated example, the UE 101 may transmit the second request when the temperature of the UE 101 reaches 40° C. Once the network 102 configures the measurements of the lower priority RAT and a cell is identified for performing the inter RAT handover, the network 102 performs the handover from the higher priority RAT to the lower priority RAT. As the configuration of measurements of the lower priority RAT and identification of the cell for the inter RAT handover is performed at each of the plurality of pre-defined temperature levels prior to the temperature of the UE 101 reaching the pre-defined maximum temperature level (42° C. in above-stated example), a seamless handover is performed and interruption caused in services provided to the UE 101 is eliminated.

In a case when the measurements related to the lower priority RAT is configured by the network 102 in the UE 101, the UE 101 may directly transmit a request to the network 102, when the temperature of the UE 101 reaches a second pre-defined temperature level among the plurality of pre-defined temperature levels. The UE 101 may transmit the request identifying a cell for performing the inter RAT handover. Since the measurements related to the lower priority RAT are configured by the network 102, the UE 101 may not detect the temperature of the UE 101 reaching the first pre-defined temperature level. As the identification of the cell for the inter RAT handover is performed at the second pre-defined temperature level prior to the temperature of the UE 101 reaching the pre-defined maximum temperature level (42° C. in above-stated example), a seamless handover is performed and interruption caused in services provided to the UE 101 is eliminated.

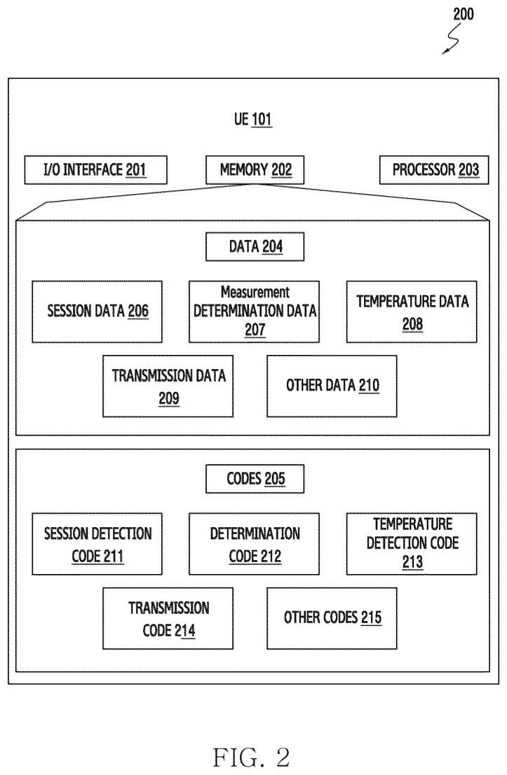

FIG. 2 illustrates a detailed diagram 200 of the UE 101 for managing the inter RAT handover of the UE 101 in the wireless communication system, in accordance with some embodiments of the disclosure. The UE 101 may include Central Processing Units 203 (also referred as “CPUs” or “a processor 203”), Input/Output (I/O) interface 201, and a memory 202. In some embodiments, the memory 202 may be communicatively coupled to the processor 203. The memory 202 stores instructions executable by the processor 203. The processor 203 may comprise at least one data processor for executing program components for executing user or system-generated requests. The memory 202 may be communicatively coupled to the processor 203. The memory 202 stores instructions, executable by the processor 203, which, on execution, may cause the processor 203 to manage the inter RAT handover of the UE 101 in the wireless communication system. In an embodiment, the memory 202 may include one or more codes 205 and data 204. The one or more codes 205 may be configured to perform the steps of the disclosure using the data 204, to manage the inter RAT handover of the UE 101 in the wireless communication system. In an embodiment, each of the one or more codes 205 may be a hardware unit which may be outside the memory 202 and coupled with the UE 101. As used herein, the term codes 205 refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more codes 205 when configured with the described functionality defined in the disclosure will result in a novel hardware. Further, the I/O interface 201 is coupled with the processor 203 through which an input signal or/and an output signal is communicated. For example, the UE 101 may transmit the one or more requests to the UE 101, using the I/O interface 201.

In one implementation, the codes 205 may include, for example, a session detection code 211, a determination code 212, a temperature detection code 213, a transmission code 214, and other codes 215. It will be appreciated that such aforementioned codes 205 may be represented as a single module or a combination of different modules. In one implementation, the data 204 may include, for example, session data 206, measurement determination data 207, temperature data 208, transmission data 209, and other data 210.

In an embodiment, the session detection code 211 may be configured to detect a communication session established via a higher priority RAT managed by the network 102. The session detection code 211 may be configured to detect the communication session to determine a requirement of monitoring a temperature of the UE 101 and performing an inter RAT handover. Herein, the session detection code 211 may determine a mode of communication of the UE 101. For example, the UE 101 may be a smartphone. The smartphone may operate in two modes i.e., 4G mode and 5G mode. The session detection code 211 may detect that a user associated with the smartphone is on a call with another user in the 5G mode. The session detection code 211 may detect the communication session established via the higher priority RAT i.e., 5G. In another example, a user may be browsing sports content on the UE 101 in the 5G mode. The session detection code 211 may detect the communication session established via the higher priority RAT i.e., 5G. Data related to the detection of the communication session may be stored as the session data 206 in the memory 202.

In an embodiment, the determination code 212 may be configured to receive the session data 206 from the session detection code 211. Further, the determination code 212 may be configured to determine whether measurements related to a lower priority RAT are configured in the UE 101 by the network 102. The determination code 212 may determine whether the measurements related to a lower priority RAT are configured in the UE 101 to identify a cell associated with the lower priority RAT to perform handover when there is a requirement based on the temperature of the UE 101.

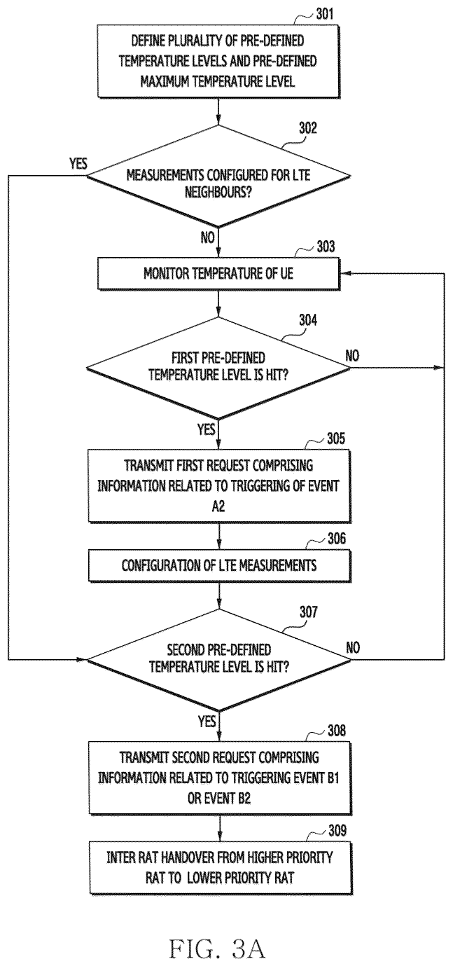

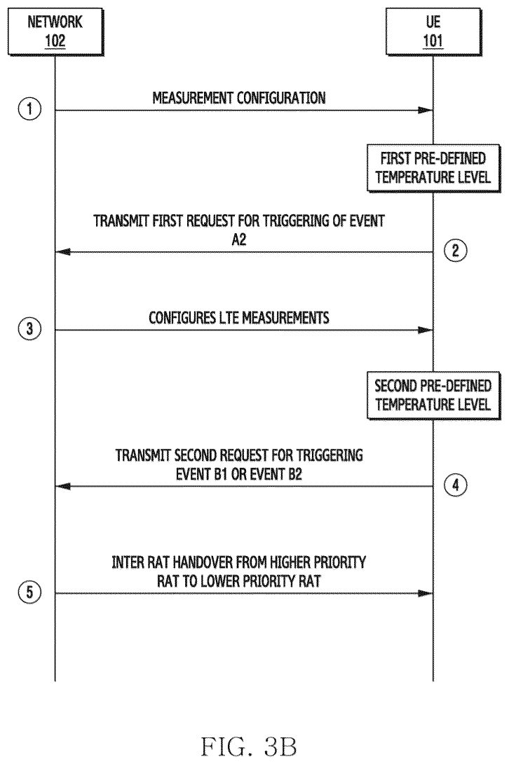

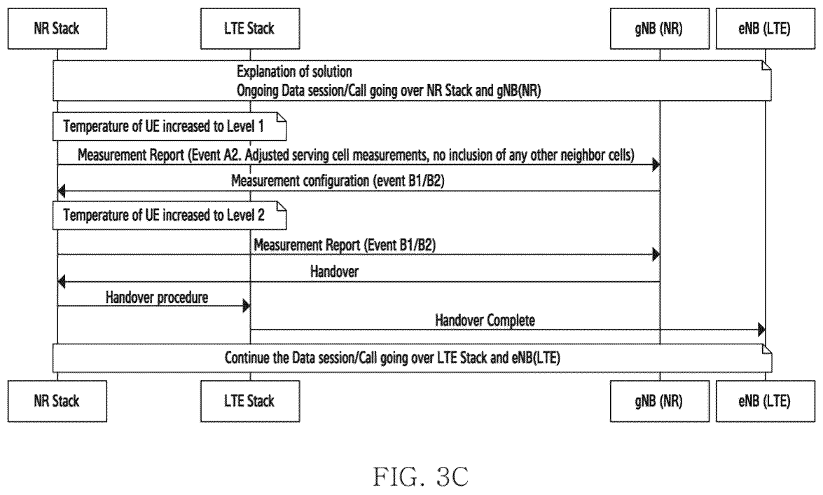

Referring to FIG. 3A, a plurality of pre-defined temperature levels and a pre-defined maximum temperature level may be defined at operation 301. At operation 302, the determination code 212 may determine whether measurements related to the lower priority RAT (for example, LTE) are configured in the UE 101 by the network 102. Referring back to FIG. 2, data related to determination of the measurements may be stored as the measurement determination data 207 in the memory 202.

In an embodiment, the temperature detection code 213 may be configured to receive the measurement determination data 207 from the determination code 212. Further, the temperature detection code 213 may be configured to detect a temperature of the UE 101 reaching each of a plurality of pre-defined temperature levels. The plurality of pre-defined temperature levels is lesser than a pre-defined maximum temperature level. The plurality of pre-defined temperature levels may be configurable based on implementation of the network 102. For example, the plurality of pre-defined temperature levels may include 36° C. and 40° C. The pre-defined maximum temperature level may include a typical temperature at which a inter RAT handover is performed. For instance, the pre-defined maximum temperature level may include a maximum acceptable level which is defined for a specific network. The temperature detection code 213 may continuously monitor the temperature of the UE 101 and may determine whether the temperature of the UE 101 reaches each of the plurality of pre-defined temperature levels.

Referring again to FIG. 3A, the temperature detection code 213 may monitor the temperature of the UE 101 at operation 303. Further, at operations 304 and 307, the temperature detection code 213 may detect the temperature of the UE 101 reaching the first pre-defined threshold level and the second pre-defined temperature level, respectively. When the temperature of the UE 101 does not reach the first pre-defined threshold level or the second pre-defined temperature level, the temperature detection code 213 may continue monitoring the temperature of the UE 101 at operation 303. Referring back to FIG. 2, data related to detection of the temperature of the UE 101 may be stored as the temperature data 208 in the memory 202.

In an embodiment, the transmission code 214 may be configured to receive the temperature data 208 from the temperature detection code 213. Further, the transmission code 214 may be configured to transmit one or more requests to the network 102 for performing the inter RAT handover, based on determination of the measurements related to the lower priority RAT and detection of the temperature of the UE 101. In a case where the network 102 has not configured the measurements related to the lower priority RAT in the UE 101, the transmission code 214 may perform following steps. Firstly, the transmission code 214 may transmit a first request to the network 102 for configuring the measurements related to the lower priority RAT in the UE 101, when the temperature of the UE 101 reaches a first pre-defined temperature level among the plurality of pre-defined temperature levels. The first request comprises information related to triggering of event A2 by the UE 101. The first request indicates that the signal strength of a serving cell associated with the UE 101 is lesser than a first threshold value configured by the network 102. The first threshold value may be pre-defined for a specific implementation of the network 102 based on the network factors. The event A2 indicates a poor network condition of the serving cell associated with the UE 101. In an example, the transmission code 214 may transmit the first request irrespective of network condition of the serving cell. For instance, the network condition of the serving cell may be poor or strong. The event A2 may be triggered so that the network 102 configures the measurements of the lower priority RAT in the UE 101 required to perform the inter RAT handover. Referring to the above-stated example, the transmission code 214 may transmit the first request when the temperature of the UE 101 reaches 36° C.

Then, the transmission code 214 may transmit a second request to the network 102, for performing the inter RAT handover from the higher priority RAT to the lower priority RAT when the temperature of the UE 101 reaches a second pre-defined temperature level among the plurality of pre-defined temperature levels. The second request comprises information related to triggering one of, event B1 and event B2 by the UE 101. The second request indicates that a signal strength of neighboring cells of the UE 101, associated with the lower priority RAT, is greater than a second threshold value configured by the network 102. The second threshold value may be pre-defined for a specific implementation of the network 102 based on the network factors The second request indicates that a signal strength of neighboring cells of the UE 101, associated with the lower priority RAT, is better than that of the serving cell of the UE 101. The second request is transmitted identifying a cell (for instance, an LTE cell), to perform the inter-RAT handover from the higher priority RAT to the lower priority RAT. Referring to the above-stated example, the transmission code 214 may transmit the second request when the temperature of the UE 101 reaches 40° C. The network 102 may perform the inter RAT handover, upon receiving the second request from the UE 101.

In the disclosure, the inter RAT handover is performed in advance to the temperature of the UE reaching the pre-defined maximum temperature level. This ensures a seamless handover without any interruption in services to the UE 101. Referring again to FIG. 3A, the transmission code 214 may transmit the first request comprising information related to triggering of event A2, at operation 305. The network 102 may configure the measurements related to the lower priority RAT (LTE measurements), based on the first request, at operation 306. Further, the transmission code 214 may transmit the second request comprising information related to triggering of event B1 or event B2, at operation 308. Referring to FIG. 3B, the network 102 may configure the measurements in the UE 101 at operation 1. The UE 101 transmits the first request at operation 2, following which the network 102 configures the LTE measurements at operation 3. At operation 4, the UE 101 transmits the second request at operation 4, following which the network 102 performs the inter RAT handover from the higher priority RAT to the lower priority RAT.

Referring back to FIG. 2, in a case wherein the measurements related to the lower priority RAT is configured by the network 102 in the UE 101, the transmission code 214 may directly transmit a request to the network 102, when the temperature of the UE 101 reaches a second pre-defined temperature level among the plurality of pre-defined temperature levels. The transmission code 214 may transmit the request identifying a cell for performing the inter RAT handover. The network 102 may perform the inter RAT handover, upon receiving the request from the UE 101.

Referring to FIG. 3C, NR stack and LTE stack may be implemented in the UE 101 for detecting the temperature and transmit the first request and the second request, to enable the inter RAT handover. Referring back to FIG. 2, the one or more requests may be stored as the transmission data 209 in the memory 202.

The other data 210 may store data, including temporary data and temporary files, generated by the one or more codes 205 for performing the various functions of the UE 101. The one or more codes 205 may also include the other codes 215 to perform various miscellaneous functionalities of the UE 101. The other data 210 may be stored in the memory 202. It will be appreciated that the one or more codes 205 may be represented as a single module or a combination of different modules.

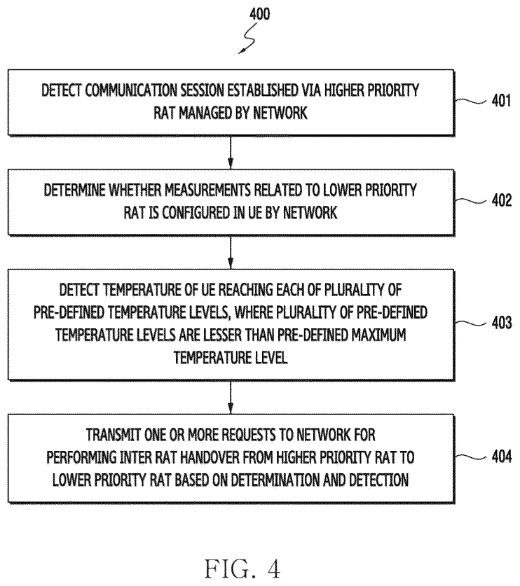

FIG. 4 illustrates operations for managing the inter RAT handover of the UE 101 in the wireless communication system, in accordance with some embodiments of the disclosure. As illustrated in FIG. 4, the method 400 may comprise one or more steps. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At operation 401, a communication session established via a higher priority RAT managed by the network 102 may be detected. Herein, a mode of communication of the UE 101 may be detected. For example, a user on a call with another user in a 5G mode may be detected. The communication session established via the higher priority RAT i.e., 5G may be detected.

At operation 402, the configuration of the measurements related to a lower priority RAT may be determined. The configuration of the measurements may be determined to identify a cell associated with the lower priority RAT to perform handover when there is a requirement based on the temperature of the UE 101.

At operation 403, a temperature of the UE 101 reaching each of a plurality of pre-defined temperature levels may be detected. The plurality of pre-defined temperature levels is lesser than a pre-defined maximum temperature level. The plurality of pre-defined temperature levels may be configurable based on implementation of the network 102. The pre-defined maximum temperature level may include a temperature level defined for a specific implementation of the network 102, at which a inter RAT handover is performed.

At operation 404, one or more requests may be transmitted to the network 102 for performing the inter RAT handover, based on the determination and the detection. In a case wherein the measurements related to the lower priority RAT is not configured in the UE 101 by the network 102, a first request may be transmitted to the network 102 for configuring the measurements related to the lower priority RAT in the UE 101, when the temperature of the UE 101 reaches the first pre-defined temperature level. The first request comprises information related to triggering of event A2 by the UE 101. The first request indicates that a signal strength of a serving cell associated with the UE 101 is lesser than a first threshold value configured by the network 102. Then, a second request may be transmitted to the network 102, for performing the inter RAT handover from the higher priority RAT to the lower priority RAT when the temperature of the UE 101 reaches a second pre-defined temperature level among the plurality of pre-defined temperature levels. The second request comprises information related to triggering one of, event B1 and event B2 by the UE 101. The second request indicates that a signal strength of neighboring cells of the UE 101, associated with the lower priority RAT, is greater than a second threshold value configured by the network 102.

In a case wherein the measurements related to the lower priority RAT is configured by the network 102 in the UE 101, a request may be transmitted to the network 102, when the temperature of the UE 101 reaches a second pre-defined temperature level among the plurality of pre-defined temperature levels.

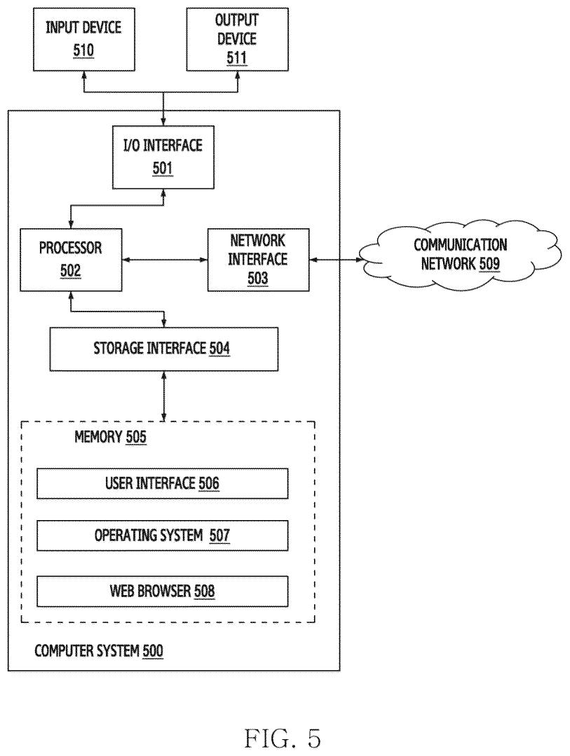

FIG. 5 illustrates a block diagram of an example computer system 500 for implementing embodiments consistent with the disclosure. In an embodiment, the computer system 500 may be the UE 101. Thus, the computer system 500 may be used to manage the inter RAT handover of the UE 101 in the wireless communication system. The computer system 500 may transmit the one or more requests to the network (for instance, a base station in the network), over a communication network 509. The computer system 500 may comprise a Central Processing Unit 502 (also referred as “CPU” or “processor”). The processor 502 may comprise at least one data processor. The processor 502 may include specialized processing units such as integrated system (bus) controllers, memory management control units, floating point units, graphics processing units, digital signal processing units, etc.

The processor 502 may be disposed in communication with one or more input/output (I/O) devices (not shown) via I/O interface 501. The I/O interface 501 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices. For example, the input device 510 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 511 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 509 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507, web browser 508 etc. In some embodiments, computer system 500 may store user/application data, such as, the data, variables, records, etc., as described in this disclosure. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 500 may implement the web browser 508 stored program component. The web browser 508 may be a hypertext viewing application, for example MICROSOFTR INTERNET EXPLORERTM, GOOGLER CHROME™MO, MOZILLAR FIREFOXTM, APPLER SAFARITM, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX™, DHTML™, ADOBER FLASH™, JAVASCRIPT™, JAVA™, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP™ ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFTR exchange, Post Office Protocol

(POP), Simple Mail Transfer Protocol (SMTP), or the like. In some embodiments, the computer system 500 may implement a mail client stored program component. The mail client may be a mail viewing application, such as APPLE® MAIL™, MICROSOFT® ENTOURAGE™ MICROSOFT® OUTLOOK™, MOZILLA® THUNDERBIRD™, etc.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

The disclosure provides a method and a UE for managing inter RAT handover in a wireless communication system. In the disclosure, a plurality of temperature levels is defined. The plurality of temperature levels is less than a maximum temperature level at which an inter RAT handover needs to be performed from a higher RAT to a lower RAT. In the disclosure, the UE performs procedures such as configuring LTE measurements, determining an LTE cell for the inter RAT handover, and the like, in advance of the temperature of the UE reaching the maximum temperature level. Hence, the network can perform the inter RAT handover of the UE prior to the temperature of the UE reaching the maximum temperature level. This leads to a seamless handover from the higher RAT to the lower RAT to avoid service interruptions to a user associated with the UE, when a temperature level of the UE is high. Thus, improving QoS provided to the user.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 shows certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

According to an embodiment, a method of managing inter Radio Access Technology (RAT) handover of a User Equipment (UE) in a wireless communication system, comprises detecting, by the UE, a communication session established via a first RAT managed by a network, detecting, by the UE, a temperature of the UE, the temperature being reaching each of a plurality of reference temperature levels, wherein the plurality of reference temperature levels are lesser than a maximum temperature level, and transmitting, by the UE, one or more requests to the network for performing inter RAT handover from the first RAT to a second RAT, based on the detected temperature of the UE.

For example, the method comprises determining, by the UE, that measurements related to the second RAT are not configured in the UE by the network, and based on the determining that the measurements related to the second RAT are not configured in the UE, transmitting at least one of a first request or a second request.

For example, the transmitting the one or more requests to the network, comprises transmitting the first request, to the network, for configuring the measurements related to the second RAT in the UE, when the temperature of the UE reaches a first reference temperature level among the plurality of reference temperature levels, and transmitting the second request, to the network, for performing the inter RAT handover from the first RAT to the second RAT in case of that the temperature of the UE reaches a second reference temperature level among the plurality of reference temperature levels.

For example, the first request comprises information related to a triggering of an event A2 by the UE. The information indicates that a signal strength of a serving cell associated with the UE is lesser than a first threshold value configured by the network.

For example, the second request comprises information related to triggering one of an event B1 and an event B2 by the UE. The information indicates that a signal strength of neighboring cells of the UE, associated with the second RAT, is greater than a second threshold value configured by the network.

For example, the method comprises receiving a message causing the UE to perform the inter RAT handover from the first RAT to the second RAT, the message comprising information for establishing another communication session via the second RAT. For example, the method comprises determining, by the UE, that measurements

related to the second RAT are configured in the UE by the network, and based on the determining that the measurements related to the second RAT in the UE are configured in the UE by the network, transmitting a third request, to the network, for performing the inter RAT handover from the first RAT to the second RAT, in case of that the temperature of the UE reaches a second reference temperature level among the plurality of reference temperature levels.

For example, the inter RAT handover from the first RAT to the second RAT is implemented in advance of the temperature of the UE reaching the maximum temperature level.

For example, the method comprises identifying that the temperature of the UE reaches the maximum temperature level, and in response to identifying that the temperature of the UE reaches the maximum temperature level, disconnecting the communication session and establish another communication session via the second RAT managed by a network.

For example, a priority of the first RAT is higher than a priority of the second RAT.

According to an embodiment, a user equipment (UE) for managing inter radio access technology (RAT) handover in a wireless communication system, comprises memory including one or more storage mediums storing instructions, and at least one processor including processing circuitry. The instructions, when being executed by the at least one processor individually or collectively, cause the UE to detect a communication session established via a first RAT managed by a network, detect a temperature of the UE, the temperature being reaching each of a plurality of reference temperature levels, wherein the plurality of reference temperature levels are lesser than a maximum temperature level, and transmit one or more requests, to the network, for performing inter RAT handover from the first RAT to the second RAT, based on the detected temperature of the UE.

For example, the instructions, when being executed by the at least one processor individually or collectively, cause the UE to determine that measurements related to the second RAT are not configured in the UE by the network, and based on the determining that the measurements related to the second RAT are not configured in the UE, transmit at least one of a first request or a second request.

For example, the instructions, when being executed by the at least one processor individually or collectively, cause the UE to transmit, to the network, the first request for configuring the measurements related to the second RAT in the UE, when the temperature of the UE reaches a first reference temperature level among the plurality of reference temperature levels, and transmit, to the network, the second request for performing the inter RAT handover from the first RAT to the second RAT, when the temperature of the UE reaches a second reference temperature level among the plurality of reference temperature levels.

For example, the first request comprises information related to triggering of an event A2 by the UE. The information indicates that a signal strength of a serving cell associated with the UE is lesser than a first threshold value configured by the network.

For example, the second request comprises information related to triggering one of an event B1 and an event B2 by the UE. The information indicates that a signal strength of neighboring cells of the UE, associated with the second RAT, is greater than a second threshold value configured by the network.

For example, the instructions, when being executed by the at least one processor individually or collectively, cause the UE to receive a message causing the UE to perform the inter RAT handover from the first RAT to the second RAT, the message comprising information for establishing another communication session via the second RAT.

For example, the instructions, when being executed by the at least one processor individually or collectively, cause the UE to determine, by the UE, that measurements related to the second RAT are configured in the UE by the network, and based on the determining that the measurements related to the second RAT in the UE are configured in the UE by the network, transmit a third request, to the network, for performing the inter RAT handover from the first RAT to the second RAT, in case of that the temperature of the UE reaches a second reference temperature level among the plurality of reference temperature levels.

For example, the inter RAT handover from the first RAT to the second RAT is implemented in advance of the temperature of the UE reaching the maximum temperature level.

For example, the instructions, when being executed by the at least one processor individually or collectively, cause the UE to identify that the temperature of the UE reaches the maximum temperature level, and in response to identifying that the temperature of the UE reaches the maximum temperature level, disconnect the communication session and establish another communication session via the second RAT managed by a network.

For example, a priority of the first RAT is higher than a priority of the second RAT.

According to an embodiment, a method of managing inter Random Access Technology (RAT) handover of a User Equipment (UE) in a wireless communication system, comprises detecting, by the UE, a communication session established via a higher priority RAT managed by a network, determining, by the UE, whether measurements related to a lower priority RAT is configured in the UE by the network, detecting, by the UE, a temperature of the UE, the temperature being reaching each of a plurality of pre-defined temperature levels, wherein the plurality of pre-defined temperature levels are lesser than a pre-defined maximum temperature level, and transmitting, by the UE, one or more requests to the network for performing inter RAT handover from the higher priority RAT to the lower priority RAT, based on the determined measurements and the detected communication session.

For example, the transmitting the one or more requests to the network, based on determining that the network is not configured the measurements related to the lower priority RAT in the UE, comprises transmitting a first request, to the network, for configuring the measurements related to the lower priority RAT in the UE, when the temperature of the UE reaches a first pre-defined temperature level among the plurality of pre-defined temperature levels, and transmitting a second request, to the network, for performing the inter RAT handover from the higher priority RAT to the lower priority RAT when the temperature of the UE reaches a second pre-defined temperature level among the plurality of pre-defined temperature levels.

For example, the transmitting the one or more requests to the network, based on determining that the network configures the measurements related to the lower priority RAT in the UE, comprises transmitting a request, to the network, for performing the inter RAT handover from the higher priority RAT to the lower priority RAT, when the temperature of the UE reaches a second pre-defined temperature level among the plurality of pre-defined temperature levels.

For example, the first request comprises information related to a triggering of an event A2 by the UE. The information indicates that a signal strength of a serving cell associated with the UE is lesser than a first threshold value configured by the network.

For example, the second request comprises information related to triggering one of an event B1 and an event B2 by the UE. The information indicates that a signal strength of neighboring cells of the UE, associated with the lower priority RAT, is greater than a second threshold value configured by the network.

For example, the inter RAT handover from the higher priority RAT to the lower priority RAT is implemented in advance of the temperature of the UE reaching the pre-defined maximum temperature level.

According to an embodiment, a User Equipment (UE) for managing inter Random Access Technology (RAT) handover in a wireless communication system, comprises at least one processor, and at least one memory. The at least one memory is configured to store processor-executable instructions, which, on execution, causes the at least one processor to detect a communication session established via a higher priority RAT managed by a network, determine whether measurements related to a lower priority RAT is configured in the UE by the network, detect a temperature of the UE, the temperature being reaching each of a plurality of pre-defined temperature levels, wherein the plurality of pre-defined temperature levels are lesser than a pre-defined maximum temperature level, and transmit one or more requests, to the network, for performing inter RAT handover from the higher priority RAT to the lower priority RAT, based on the determined measurements and the detected temperature of the UE.

For example, the at least one processor is further configured to transmit the one or more requests to the network, based on determining that the network is not configured the measurements related to the lower priority RAT in the UE, by: transmitting, to the network, a first request for configuring the measurements related to the lower priority RAT in the UE, when the temperature of the UE reaches a first pre-defined temperature level among the plurality of pre-defined temperature levels, and transmitting, to the network, a second request for performing the inter RAT handover from the higher priority RAT to the lower priority RAT, when the temperature of the UE reaches a second pre-defined temperature level among the plurality of pre-defined temperature levels.

For example, the at least one processor is further configured to transmit the one or more requests to the network, based on determining that the network configures the measurements related to the lower priority RAT in the UE, by transmitting, to the network, a request for performing the inter RAT handover from the higher priority RAT to the lower priority RAT, when the temperature of the UE reaches a second pre-defined temperature level among the plurality of pre-defined temperature levels.

For example, the first request comprises information related to triggering of an event A2 by the UE. The information indicates that a signal strength of a serving cell associated with the UE is lesser than a first threshold value configured by the network.

For example, the second request comprises information related to triggering one of an event B1 and an event B2 by the UE. The information indicates that a signal strength of neighboring cells of the UE, associated with the lower priority RAT, is greater than a second threshold value configured by the network.

For example, the inter RAT handover from the higher priority RAT to the lower priority RAT is implemented in advance of the temperature of the UE reaching the pre-defined maximum temperature level.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a randm-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

No claim element is to be construed under the provisions of 35 U.S.C. § 112, sixth paragraph, unless the element is expressly recited using the phrase “means for” or “means.”

What is claimed is:

1. A method of managing inter Radio Access Technology (RAT) handover of a User Equipment (UE) in a wireless communication system, the method comprising:
detecting, by the UE, a communication session established via a first RAT managed by a network;
detecting, by the UE, a temperature of the UE, the temperature being reaching each of a plurality of reference temperature levels, wherein the plurality of reference temperature levels are lesser than a maximum temperature level; and
transmitting, by the UE, one or more requests to the network for performing inter RAT handover from the first RAT to a second RAT, based on the detected temperature of the UE.

2. The method of claim 1, wherein the method comprises:
determining, by the UE, that measurements related to the second RAT are not configured in the UE by the network; and
based on the determining that the measurements related to the second RAT are not configured in the UE, transmitting at least one of a first request or a second request.

3. The method of claim 2, wherein the transmitting the one or more requests to the network, comprises:
transmitting the first request, to the network, for configuring the measurements related to the second RAT in the UE, when the temperature of the UE reaches a first reference temperature level among the plurality of reference temperature levels; and
transmitting the second request, to the network, for performing the inter RAT handover from the first RAT to the second RAT in case of that the temperature of the UE reaches a second reference temperature level among the plurality of reference temperature levels.

4. The method of claim 3, wherein the first request comprises information related to a triggering of an event A2 by the UE, and
wherein the information indicates that a signal strength of a serving cell associated with the UE is lesser than a first threshold value configured by the network.

5. The method of claim 3, wherein the second request comprises information related to triggering one of an event B1 and an event B2 by the UE, and
wherein the information indicates that a signal strength of neighboring cells of the UE, associated with the second RAT, is greater than a second threshold value configured by the network.

6. The method of claim 5, wherein the method comprises receiving a message causing the UE to perform the inter RAT handover from the first RAT to the second RAT, the message comprising information for establishing another communication session via the second RAT.

7. The method of claim 2, wherein the method comprises:
determining, by the UE, that measurements related to the second RAT are configured in the UE by the network; and
based on the determining that the measurements related to the second RAT in the UE are configured in the UE by the network, transmitting a third request, to the network, for performing the inter RAT handover from the first RAT to the second RAT, in case of that the temperature of the UE reaches a second reference temperature level among the plurality of reference temperature levels.

8. The method of claim 1, wherein the inter RAT handover from the first RAT to the second RAT is implemented in advance of the temperature of the UE reaching the maximum temperature level.

9. The method of claim 8, wherein the method comprises:
identifying that the temperature of the UE reaches the maximum temperature level; and
in response to identifying that the temperature of the UE reaches the maximum temperature level, disconnecting the communication session and establish another communication session via the second RAT managed by a network.

10. The method of claim 1, wherein a priority of the first RAT is higher than a priority of the second RAT.

11. A User Equipment (UE) for managing inter Radio Access Technology (RAT) handover in a wireless communication system, the UE comprising:
memory including one or more storage mediums storing instructions; and
at least one processor including processing circuitry,
wherein the instructions, when being executed by the at least one processor individually or collectively, cause the UE to:
detect a communication session established via a first RAT managed by a network;
detect a temperature of the UE, the temperature being reaching each of a plurality of reference temperature levels, wherein the plurality of reference temperature levels are lesser than a maximum temperature level; and
transmit one or more requests, to the network, for performing inter RAT handover from the first RAT to the second RAT, based on the detected temperature of the UE.

12. The UE of claim 11, wherein the instructions, when being executed by the at least one processor individually or collectively, cause the UE to:
determine that measurements related to the second RAT are not configured in the UE by the network; and
based on the determining that the measurements related to the second RAT are not configured in the UE, transmit at least one of a first request or a second request.

13. The UE of claim 12, wherein the instructions, when being executed by the at least one processor individually or collectively, cause the UE to:
transmit, to the network, the first request for configuring the measurements related to the second RAT in the UE, when the temperature of the UE reaches a first reference temperature level among the plurality of reference temperature levels; and
transmit, to the network, the second request for performing the inter RAT handover from the first RAT to the second RAT, when the temperature of the UE reaches a second reference temperature level among the plurality of reference temperature levels.

14. The UE of claim 13, wherein the first request comprises information related to triggering of an event A2 by the UE, and
wherein the information indicates that a signal strength of a serving cell associated with the UE is lesser than a first threshold value configured by the network.

15. The UE of claim 13, wherein the second request comprises information related to triggering one of an event B1 and an event B2 by the UE, and
wherein the information indicates that a signal strength of neighboring cells of the UE, associated with the second RAT, is greater than a second threshold value configured by the network.

16. The UE of claim 15, wherein the instructions, when being executed by the at least one processor individually or collectively, cause the UE to:
receive a message causing the UE to perform the inter RAT handover from the first RAT to the second RAT, the message comprising information for establishing another communication session via the second RAT.

17. The UE of claim 12, wherein the instructions, when being executed by the at least one processor individually or collectively, cause the UE to:
determine, by the UE, that measurements related to the second RAT are configured in the UE by the network; and
based on the determining that the measurements related to the second RAT in the UE are configured in the UE by the network, transmit a third request, to the network, for performing the inter RAT handover from the first RAT to the second RAT, in case of that the temperature of the UE reaches a second reference temperature level among the plurality of reference temperature levels.

18. The UE of claim 7, wherein the inter RAT handover from the first RAT to the second RAT is implemented in advance of the temperature of the UE reaching the maximum temperature level.

19. The UE of claim 18, wherein the instructions, when being executed by the at least one processor individually or collectively, cause the UE to:
identify that the temperature of the UE reaches the maximum temperature level; and
in response to identifying that the temperature of the UE reaches the maximum temperature level, disconnect the communication session and establish another communication session via the second RAT managed by a network.

20. The UE of claim 11, wherein a priority of the first RAT is higher than a priority of the second RAT.
